(19) United States
(12) Patent Application Publication
(10) Pub. No.: US 2004/0124096 A1
(43) Pub. Date: Jul. 1, 2004

(54) Pcb treating device and pcb treating method by electrolysis

(76) Inventors: Kenji Suzuki, Saitama (JP); Kisaku Tomaru, Tokyo (JP)

Correspondence Address: Koda & Androlia, Suite 1430, 2029 Century Park East, Los Angeles, CA, 90067-3024, US

(21) Appl. No.: 10/478,455

(22) PCT Filed: May 16, 2002
(86) PCT No.: PCT/JP02/04722

(30) Foreign Application Priority Data
May 23, 2001 (JP) 2001-191987

(51) Int. Cl. C02F 1/461

(52) U.S. Cl. 205/688; 204/242; 204/229.4

(57) ABSTRACT

Toxic PCB has been broadly used as insulating oil in electric equipment such as capacitors, transformers and the like. Since the PCB is a refractory organic compound, the disposal of PCB is not advanced until now. This is a great social problem in Japan and the world. Thus, the early disposal of PCB is demanded.

The conventional PCB disposing systems include a burnout type high-temperature disposing system and a chemical decomposing system. However, the high-temperature burning system is not satisfactorily improved due to various problems such as a difficulty of control for a furnace, a problem of disposing the ash containing non-decomposed PCB, a problem of generation of dioxin in lower processing temperature, a problem of movement of the PCB and a problem of not obtaining the agreement of inhabitants. Moreover, the chemical decomposing system raises various other problems in that a plant must be constructed with a huge investment that is said to be equal to 40 hundred millions per plant, that PCB must be transported to the PCB disposing plant and that the PCB disposing speed in the plan is too slow.

The present invention provides a novel PCB electrolyzing and disposing method and apparatus based on a new idea in which the PCB used as electrically insulating oil can be electrolyzed by passing the electricity through the PCB. The PCB disposing apparatus of the present invention may be portable. Thus, the apparatus can be moved to any PCB storage place to dispose the PCB in place without transportation of the PCB. In addition to the introduction of the PCB into an electrolyzing tank, the PCB may be electrolyzed by pouring water into the container of equipment containing the remaining PCB, inserting the inserting portion including the electric-wave rod, electrode rods and others into the water to electrolyze the PCB. A PCB-polluted container may be placed in a large-sized disposing tank for electrolysis.

The system of the present invention may be used as a soil improving apparatus by placing PCB- or dioxin-polluted soil in a disposing tank and electrolyzing the PCB or dioxin therein.

The apparatus of the present invention may be manufactured in smaller to larger sizes, depending on processing scale, and may be manufactured as a portable apparatus, as a large-scaled plant or as an integral unit mounted on a vehicle. Moreover, the system of the present invention can dispose the PCB with a greatly reduced cost and in an increased speed, in comparison with the prior art. According to the present invention, the disposal of PCB can be sharply be accelerated in Japan and the world.

### TECHNICAL FIELD

The present invention relates to an apparatus and method for PCB electrolysis invented by finding the fact that PCB itself can be decomposed by mixing an electrolysis promoting liquid such as water or acetonitrile solvent into virulently poisonous PCB containing liquid or soil and electrolyzing such a mixture.

### BACKGROUND ART

The conventional PCB disposing apparatus and method include a high-temperature incinerating apparatus and method for staying and incinerating an atomized PCB for a time period of two or more seconds in a furnace heated up to a temperature equal to or higher than 1100 degrees Celsius and a chemical decomposing apparatus and method provided by the dechlorinating and decomposing system in which the chemical reaction is used to replace the chlorine of PCB with hydrogen to form a non-PCB substance.

In the conventional high-temperature incinerating system and method, there are various problems such as a difficulty of control in the furnace heated up to high temperature, an anxiety about ash containing non-decomposed PCB, low-temperature exhaust fumes providing a danger of producing coplanar PCB and dioxin, an anxiety about an agreement of neighborhood people and a difficulty in moving and disposing PCB after stored in the other place.

The conventional chemical decomposing system and method require a huge investment which is called to be about 40 hundred millions yen per plant. Moreover, there is a further problem in that PCB must be transported to and disposed in a specific plant.

It is therefore an object of the present invention to provide a PCB electrolyzing method and apparatus, rather than the thermal and chemical decomposing systems.

Another object of the present invention is to provide a PCB disposing apparatus and method which can overcome various problems such as a difficulty of control in the high-temperature incinerator, a problem in the generation of a poisonous gas due to incineration, a problem in disposing the ash containing non-decomposed PCB and a problem in the generation of coplanar PCB and dioxin and which can provide a portable PCB disposing unit capable of being moved to the PCB storage spot, can provide an inexpensive system in comparison with the large-scaled chemical decomposing plants and can obtain the agreement of neighborhood people based on its higher safety.

### DISCLOSURE OF THE INVENTION

The inventors have embodied the apparatus and method of the present invention by finding that PCB itself can be decomposed by electrolyzing a PCB containing liquid from the result of every effort to overcome the aforementioned problems in the prior art.

Although the prior art has not had an idea to electrolyze PCB which has been used as an electrically insulating oil by causing electricity to pass through the PCB, the inventors directed their attention to the fact that when water was added into PCB, the latter became electrically conductive. Thus, the inventors obtained an apparatus and method for electrolyzing PCB by extracting and replacing the chlorine of the PCB with hydrogen when a high-voltage current is passed through a mixture of PCB and water to electrolyze both the water and PCB.

In other words, the present invention provides a PCB electrolyzing apparatus characterized by comprising a container for receiving polychlorinated biphenyl (PCB) or PCB containing liquid or a tank for receiving the PCB containing liquid from the container, wherein an electrolysis promoting liquid such as water or acetonitrile solvent is mixed into PCB to form a liquid mixture, an inserting portion having a metallic anode electrode rod or plate and a metallic cathode electrode rot or plate, which are to be inserted into the liquid mixture to electrolyze the PCB, and a main body portion connected to the inserting portion through a cable for producing a high-voltage current.

Moreover, the system of the present invention may promote the electrolysis of PCB by using an electric-wave rod for generating an electric wave such as supersonic wave, short wave, high frequency and the like to improve the efficiency of mixing the PCB and water as well as the electrical conductivity of the mixture.

In addition, if the system of the present invention has an agitating device for agitating the liquid mixture of PCB, the electrolysis of PCB may be further promoted since the upper layer of oil is further stirred by the agitating device.

The present invention further provides a PCB disposing system and method which can regulate the voltage and current to adjust the concentration and amount of PCB.

The present invention further provides a PCB electrolyzing system and method which is characterized by a plurality of the aforementioned electrode rods or plates and a plurality of electric-wave rods and which can perform a large-scaled process for disposing the PCB.

The present invention further provides a PCB disposing method comprising a first step of introducing an electrolysis promoting liquid such as water or acetonitrile solvent into a container holding PCB or PCB containing liquid or a tank received the PCB containing liquid from the container and mixing the electrolysis promoting liquid with the PCB containing liquid, a second step of increasing the electrical conductivity of the liquid mixture using an electric-wave rod for producing an electric wave such as supersonic wave, short wave, high-frequency wave or the like as well as an agitating device, and a third step of electrolyzing the PCB using an anode electrode rod or plate and a cathode electrode rod or plate, which are made of metal and which are connected to a main body portion for producing a high-voltage current through a cable.

### BRIEF DESCRIPTION OF DRAWING

FIG. 1 is a schematic view of PCB electrolyzing apparatus.

### THE BEST MODE FOR CARRYING OUT THE INVENTION

A PCB electrolyzing apparatus and method according to the present invention will be described in more detail with reference to the accompanying drawing.

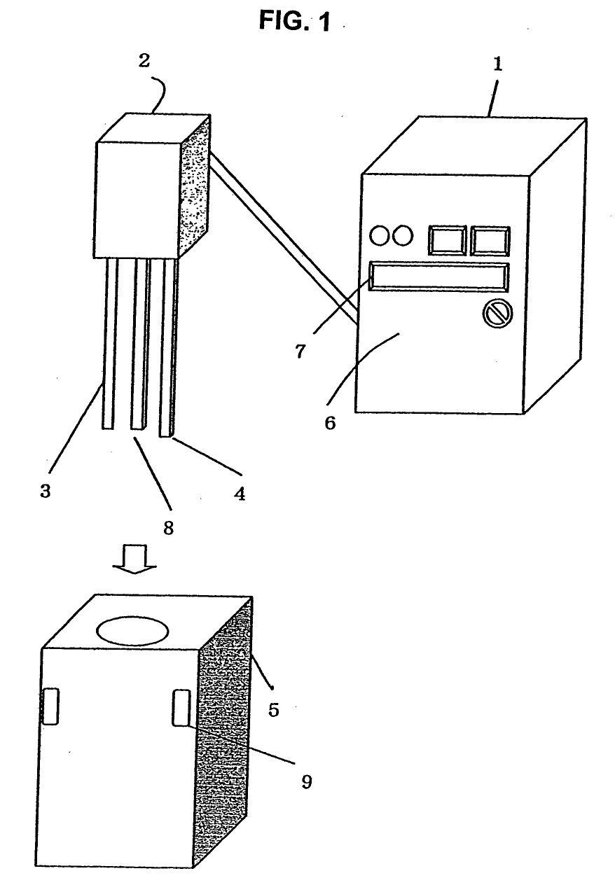

Referring to FIG. 1, a PCB electrolysis tank 5 holds a PCB containing liquid. Tap water is poured into the tank 5 so that it is mixed with the PCB containing liquid. An anode electrolysis rod 3 made of titanium-plated copper and a cathode electrolysis rod 4 made of aluminum, which are connected to a high-voltage current generator 6 and electric-wave generator 7 in a main body portion 1, are then inserted into the PCB electrolysis tank 5 together with a supersonic wave generating electric-wave rod 8. A three-phase supersonic wave power source of 200 volts and electrolysis power source in the main body are then powered on. Since the supersonic wave decouples the clusters in the water, the PCB can be better mixed with the water to increase the electrical conductivity of the PCB and to promote the electrolysis. When the voltage of 100-600V is applied to the liquid mixture in the tank from the high-voltage current generator 6 in the main body, a direct current of 10-50 amperes is generated in and passed through the liquid mixture to electrolyze both the water and PCB. As the water is electrolyzed to generate hydrogen, the hydrogen releases electrons into the water. Since the chlorine in the PCB has 17 electrons and makes stable if the number of electros becomes equal to 18, the chlorine will take one electron among the electrons generated in the water. Thus, the chlorine will be separated from the PCB to provide chlorine ions in the water through the electrolysis. After the chlorine has been extracted from the PCB, the hydrogen replaces with the chlorine to change the PCB to an innoxious biphenyl. The chlorine ions in the water react with calcium, potassium and magnesium to form a chlorination compound. The PCB is decomposed for a brief time, about 30 minutes.

### POSSIBILITY OF INDUSTRIAL APPLICATION

The present invention provides the PCB disposing system and method which is useful for the early extermination on the deadly poison PCB involving various severe problems in Japan and the world, such as deterioration of the PCB storage places, leakage of the PCB due to a disaster such as arthquakes or the like, personnel expenses with the severe PCB storage, maintenance costs for facilities and repairs.

A further feature of the present invention is that a great variety of smaller and larger electrolysis systems using the same principle can be developed as series. For smaller scale, the electrolysis system of the present invention may be mounted on a movable vehicle so that it can be moved to any PCB storage place. For larger scale, the system of the present invention may be installed as a large-scaled plant.

The present invention can dispose the PCB which has been employed as insulation oil in high- and low-voltage transformers. Even the remaining PCB in a transformer can be electrolyzed by pouring any electrolyzing liquid such as water into the container of the transformer.

PCB used as sealant in a high-voltage capacitor can similarly be disposed.

The PCB disposing system of the present invention can further be used to dispose insulating oils which have been used in power stations; buildings; hospitals; railways such as subways, the Sinkansen and other; capacitors in ships and jet airplanes.

The PCB disposing system of the present invention can further be used to electrolyze and wash PCB by placing PCB-polluted containers in a large-sized disposing tank.

The PCB disposing system of the present invention can further be used to dispose dioxin. The PCB disposing system of the present invention may be used as a soil clarifier in which PCB- or dioxin-polluted soil is placed in a disposing tank and then water is poured into the tank to mix it with the PCB for electrolysis.

The PCB disposing system of the present invention can be used to dispose the PCB by moving it to any PCB storage plane without movement of the PCB.

The PCB disposing system of the present invention can be used to dispose the PCB by placing PCB polluted containers in a large-scaled disposing tank and then inserting the inserting portion of the present invention into the tank. The PCB disposing system of the present invention can be manufactured very inexpensively.

What is claimed is:

1. A PCB electrolyzing apparatus characterized by comprising a container for receiving polychlorinated biphenyl (PCB) or PCB containing liquid or a tank for receiving the PCB containing liquid from the container, wherein an electrolysis promoting liquid such as water or acetonitrile solvent is mixed into PCB to form a liquid mixture, an inserting portion having a metallic anode electrode rod or plate and a metallic cathode electrode rot or plate, which are to be inserted into the liquid mixture to electrolyze the PCB, and a main body portion connected to the inserting portion through a cable for producing a high-voltage current.

2. A PCB electrolyzing apparatus characterized by comprising a container for receiving PCB or PCB containing liquid or a tank for receiving the PCB containing liquid from the container, wherein an electrolysis promoting liquid such as water or acetonitrile solvent is mixed into PCB to form a liquid mixture, an inserting portion having a metallic anode electrode rod or plate, a metallic cathode electrode rot or plate and an electric-wave rod for generating an electric wave such as supersonic wave, short wave, high-frequency wave or the like, all of which rods are to be inserted into the liquid mixture to electrolyze the PCB, and a main body portion for generating a high-voltage current and electric wave, said main body portion being connected to the inserting portion through a cable for producing a high-voltage current.

3. The PCB electrolyzing apparatus as claimed in claim 1 or 2, characterized by that it comprises a plurality of said electrode rods or plates and a plurality of electric-wave rods.

4. The PCB electrolyzing apparatus as claimed in any one of claims 1-3, characterized by that it has a function of pulsing the electric wave.

5. The PCB electrolyzing apparatus as claimed in any one of claims 1-4, characterized by that it has a function of regulating the voltage and current in said main body portion.

6. The PCB electrolyzing apparatus as claimed in any one of claims 1-5, characterized by that it further comprises an agitating device for agitating PCB oil floating on the liquid level in the disposing tank resulting from the electrolysis.

7. The PCB electrolyzing apparatus as claimed in any one of claims 1-6, characterized by that it further comprises a device for warming the water such that the water will be better mixed with the PCB in said disposing tank.

8. A PCB electrolyzing vehicle wherein said apparatus is mounted on a motorcar to form an integral unit.

9. A PCB electrolyzing method comprising a first step of introducing an electrolysis promoting liquid such as water or acetonitrile solvent into a container holding PCB or PCB containing liquid or a tank received the PCB containing liquid from the container and mixing the electrolysis promoting liquid with the PCB containing liquid to form a liquid mixture and a second step of increasing the electrical conductivity of the liquid mixture through an electric-wave rod for generating an electric wave such as supersonic wave, short wave, high-frequent wave or the like as well as an agitating device and electrolyzing the PCB by flowing a high-voltage current and by metallic anode and cathode electrode rods or plates.
